(19) United States
(12) Patent Application Publication
(10) Pub. No.: US 2019/0217532 A1
(43) Pub. Date: Jul. 18, 2019

(54) Additive and Subtractive Manufacturing System

(71) Applicants: Jonathan R. Schroeder, South Beloit, IL (US); Robert Schroeder, Machesney Park, IL (US); Joseph A. Binka, Belvidere, IL (US)

(72) Inventors: Jonathan R. Schroeder, South Beloit, IL (US); Robert Schroeder, Machesney Park, IL (US); Joseph A. Binka, Belvidere, IL (US)

(73) Assignee: 3DP Unlimited, LLC d/b/a 3D Platform, Roscoe, IL (US)

(21) Appl. No.: 16/331,032

(22) PCT Filed: Sep. 6, 2017
(86) PCT No.: PCT/US2017/050276

§ 371 Date: Mar. 6, 2019

Related U.S. Application Data
(60) Provisional application No. 62/384,568, filed on Sep. 7, 2016.

(51) Int. Cl. B29C 64/118; B29C 64/379; B29C 64/393

(52) U.S. Cl. CPC B29C 64/118; B33Y 10/00; B29C 64/393; B29C 64/379

(57) ABSTRACT

An additive and subtractive manufacturing system and method of manufacturing is provided. The system includes a print bed and both an additive machine and a subtractive machine. The additive machine will dispense material onto the print bed and the additive machine will be able to perform subtractive manufacturing on the material dispensed onto the print bed. The additive machine and subtractive machine will be mounted to actuators for moving the machines in three-dimensions within a working zone adjacent the print bed. The system may include placement machines for placing pre-made components in the product during the manufacturing process.

### FIELD OF THE INVENTION

This invention generally relates to additive manufacturing processes.

### BACKGROUND OF THE INVENTION

Additive manufacturing where products are made by dispensing numerous layers of material (also referred to as “three-dimensional printing” or “fused filament fabrication”) has become widely popular for manufacturing products. However, there is an ever increasing desire to produce better, more complex, more precise products using additive manufacturing techniques.

Numerous issues exist in current additive manufacturing systems. For instance, additive manufacturing can produce tolerances that are unacceptable in a traditional manufacturing environment. Cycle times of traditional additive manufacturing can be very long. It can be desirable to perform subsequent subtractive manufacturing after additive manufacturing. However, refixturing of an object that has been additively manufactured can be time consuming, costly, and add another operation that can allow for a tolerance error. Also, traditional additive machines are limited to forming small components and they are not adaptable to be expanded for producing larger components.

This invention provides improvements over the current state of the art as it relates to additive manufacturing.

### BRIEF SUMMARY OF THE INVENTION

A new and improved manufacturing system and method of manufacturing is provided. More particularly, a new additive and subtractive manufacturing system and method is provided.

In one embodiment, an additive and subtractive manufacturing system for forming a product including a print bed, a first additive machine and a first subtractive machine is provided. The first additive machine is mounted to a first additive machine actuator for three-dimensional motion relative to the print bed for dispensing a first material onto the print bed within a working zone. The first subtractive machine is mounted to a first subtractive machine actuator for three-dimensional motion relative to the print bed for removing material dispensed on the print bed within the working zone from the first additive machine.

In one embodiment, the print bed is movable relative to the first and second additive machines to a first orientation where the working zone is positioned proximate the first additive machine and movable relative to a second orientation where the working zone is positioned proximate the first subtractive machine.

In one embodiment, the print bed rotates about an axis of rotation between the first and second orientations. The first additive machine is angularly offset from the first subtractive machine about the axis of rotation.

In one embodiment, the first subtractive machine includes a sensor that measures a position of the print bed or the first material to determine a location of the first subtractive machine.

In one embodiment, the sensor is a contact sensor that directly contacts the print bed or the first material.

In one embodiment, the sensor is a non-contact sensor.

In one embodiment, the first additive machine includes a sensor that measures a position of the print bed or the first material to determine a location of the first subtractive machine.

In one embodiment, the sensor is a contact sensor that directly contacts the print bed or the first material.

In one embodiment, the sensor is a non-contact sensor.

In one embodiment, the system includes a tooling position monitoring system. The tooling position system includes a first sensor and at least first and second transmitters. The first sensor receives signals from the first and second transmitters. One of the first sensor and at least first and second transmitters is attached to at least one of the first additive machine and the first subtractive machine and at least two of the first sensor and at least first and second transmitters are in fixed positions. The tooling position monitoring system can determine the position of the one of the first sensor and at least first and second transmitters attached to at least one of the first additive machine and the first subtractive machine based on the first sensor receiving signals from the first and second transmitters.

In one embodiment, the first sensor is attached to and movable with the first additive machine and the first and second transmitters are in fixed positions.

In one embodiment, the first and second transmitters transmit either a radio signal or a light signal.

In one embodiment, at least one sensor is mounted to the print bed to detect a position of the bed. A controller is configured to sense a change in position of the at least one sensor due to thermal expansion and contraction of the print bed and to and adjust control of the first additive machine and first subtractive machine based on the sensed change in position of the at least one sensor.

In one embodiment, at least one sensor is mounted to the first additive machine for sensing a temperature of the first material after the first material has been dispensed. A controller is configured to use the sensed temperature to determine whether a second material can be placed on the first material.

In one embodiment, the first and second materials are the same type of material but the first material is a first layer of material and the second material is a second layer of material placed in contact with the first layer of material.

In one embodiment, a waste material removal system for removing waste material removed by the first subtractive machine from the working zone.

In one embodiment, the waste material removal system is operably moved with the first subtractive machine.

In one embodiment, the waste material removal system is a vacuum system.

In one embodiment, an environmental enclosure surrounds the first additive machine, first subtractive machine and the print bed.

In one embodiment, the environmental enclosure is a movable enclosure to provide access to the work zone for removal of a component formed in the working zone.

In one embodiment, the environmental enclosure includes a plurality of sections that fold or slide adjacent one another to provide access to the working zone.

In one embodiment, the environmental enclosure includes a plurality of sections that stack inside one another to provide access to the working zone.

In one embodiment, a second additive machine is provided for dispensing a second material in the working zone.

In one embodiment, the first and second materials are different from one another in at least one of material type, material size, or material form.

In one embodiment, the first and second additive machines are different from one another in at least one of type or size.

In one embodiment, the first additive machine is a spool fed extruder and the second additive machine is a pellet fed extruder.

In one embodiment, a placement machine is mounted to a placement machine actuator for three-dimensional motion relative to the print bed for manipulating a pre-made component within the working zone.

In one embodiment, the placement machine includes a gripping end effector and is configured to initially grip the pre-made component in a first location and moving the pre-made component to a second location. The second location is within the working zone. The end effector releases the pre-made component when it is located within the working zone.

In one embodiment, the first additive machine is configured to dispense the first material before and after the placement machine manipulates the pre-made component.

In one embodiment, the first additive machine is configured to dispense a first portion of the first material prior to manipulation of the pre-made component with the placement machine and to dispense a second portion of the first material after the placement machine releases the pre-made component.

In one embodiment, a surface preparation system is configured to prepare a first portion of the first material to receive a second portion of the first material after the first portion of the first material has been processed by the first subtractive machine.

In one embodiment, the first additive machine is a pellet fed extruder. The system further includes a hopper for storing the first material in a pellet form prior to being dispensed in the working zone on the print bed.

In one embodiment, the hopper is operably fixed to the first additive machine actuator.

In one embodiment, the hopper includes a plurality of storage compartments for storing more than one type of pellet.

In one embodiment, a filling station is located in a fixed location having a reserve supply of pellets the hopper. The first additive machine actuator is configured to move the hopper to the filling station to add additional pellets to the hopper from the reserve supply.

In one embodiment, a pellet supply system between the hopper and the first additive machine is provided to maintain environmental conditions of the pellets prior to being dispensed.

In one embodiment, the pellet supply system includes a dryer to prevent the pellets from absorbing moisture.

In one embodiment, the hopper is located in a fixed position and does not move with the first additive machine as the first additive machine is moved within three dimensions within the working zone.

In one embodiment, the first additive machine is a spool fed extruder including a spool for supplying the first material to the first additive machine. The spool is mounted to the first additive machine.

In one embodiment, a spool reloader is configured to automatically weld a tail end of a first spool of material being used by the first additive machine with a lead end of a second spool of material when the first spool runs empty.

In one embodiment, the additive machine has a plurality of extruder heads for dispensing different materials. An automatic tool changer is configured for hands free swapping between the plurality of extruder heads.

In one embodiment, a controller controls the first additive machine and the first subtractive machine. The controller communicates with the first additive machine and the first subtractive machine wirelessly.

In one embodiment, at least one of the first additive machine actuator and first subtractive machine actuator is a moving gantry.

In one embodiment, a power rail system delivers voltage power to the moving gantry to power the corresponding first additive machine or first subtractive machine.

In one embodiment, a controller controls operation of the corresponding first additive machine or first subtractive machine carried by the at least one of the first additive machine actuator and first subtractive machine actuator that is a moving gantry. The controller communicates control commands to the corresponding first additive machine or first subtractive machine wirelessly.

In one embodiment, the first additive machine actuator includes a gantry configured to move linearly along a guide rail forming a straight axis. The first subtractive machine actuator includes a gantry configured to move linearly along the guide rail. The guide rail is formed from a plurality of guide rail sections such that a length of the guide rail along the straight axis can be adjusted and the print bed is formed from a plurality of print bed sections such that a length of the print bed along the straight axis can be adjusted.

In another embodiment, methods of manufacturing using an additive and subtractive manufacturing system outlined above are provided.

In one embodiment, a method of manufacturing a product using an additive and subtractive manufacturing system includes dispensing a first material onto the print bed within the working zone; and removing a portion of the first material within the work zone.

In one embodiment, the print bed is movable relative to the first and second additive machines to a first orientation where the working zone is positioned proximate the first additive machine and movable relative to a second orientation where the working zone is positioned proximate the first subtractive machine. The method further includes repositioning the print bed relative to the first and second additive machines by moving the print bed between the first and second orientations.

In one embodiment, the print bed rotates about an axis of rotation between the first and second orientations. The first additive machine is angularly offset from the first subtractive machine about the axis of rotation. The method further includes rotating the print bed about the axis of rotation.

In one embodiment, the first subtractive machine includes a sensor that measures a position of the print bed or the first material to determine a location of the first subtractive machine. The method further includes sensing a position of the print bed or the first material with the sensor.

In one embodiment, the sensor is a contact sensor that directly contacts the print bed or the first material. The step of sensing includes directly contacting the print bed or the first material.

In one embodiment, the sensor is a non-contact sensor.

In one embodiment, the first additive machine includes a sensor that measures a position of the print bed or the first material to determine a location of the first subtractive machine. The method further comprises sensing a position of the print bed or the first material with the sensor.

In one embodiment, the sensor is a contact sensor that directly contacts the print bed or the first material.

In one embodiment, the sensor is a non-contact sensor.

In one embodiment, the method includes determining a position of at least one of the first additive machine and the first subtractive machine with a tooling position monitoring system. The tooling positioning system including a first sensor and at least first and second transmitters. The method further includes receives signals from the first and second transmitters with the first sensor. One of the first sensor and at least first and second transmitters is attached to at least one of the first additive machine and the first subtractive machine and at least two of the first sensor and at least first and second transmitters are in fixed positions. The tooling position monitoring system determines the position of the one of the first sensor and at least first and second transmitters attached to at least one of the first additive machine and the first subtractive machine based on the first sensor receiving signals from the first and second transmitters.

In one embodiment, the method includes moving the first sensor with the first additive machine and the first and second transmitters are in fixed positions.

In one embodiment, the first and second transmitters transmit either a radio signal or a light signal.

In one embodiment, the method includes detecting a position of the print bed with at least one sensor mounted to the print bed. The method includes sensing a change in position of the at least one sensor, with a controller, due to thermal expansion and contraction of the print bed. The method includes adjusting control of the first additive machine and first subtractive machine based on the sensed change in position of the at least one sensor.

In one embodiment, the method includes sensing a temperature of the first material, with at least one sensor mounted to the first additive machine, after the first material has been dispensed. The method includes determining whether a second material can be placed on the first material, based on the sensed temperature.

In one embodiment, the first and second materials are the same type of material but the first material is a first layer of material and the second material is a second layer of material placed in contact with the first layer of material.

In one embodiment, the method includes removing waste material removed by the first subtractive machine with a waste material removal system, from the working zone.

In one embodiment, the method includes operably moving the waste material removal system with the first subtractive machine.

In one embodiment, the waste material removal system is a vacuum system.

In one embodiment, the method includes surrounding the first additive machine, first subtractive machine and the print bed by an environmental enclosure.

19 In one embodiment, the environmental enclosure is a movable enclosure to provide access to the work zone for removal of a component formed in the working zone.

In one embodiment, the environmental enclosure includes a plurality of sections that fold or slide adjacent one another to provide access to the working zone.

In one embodiment, the environmental enclosure includes a plurality of sections that stack inside one another to provide access to the working zone.

In one embodiment, the method includes dispensing a second material in the work zone with a second additive machine.

In one embodiment, the first and second materials are different from one another in at least one of material type, material size, or material form.

In one embodiment, the first and second additive machines are different from one another in at least one of type or size.

In one embodiment, the first additive machine is a spool fed extruder and the second additive machine is a pellet fed extruder.

In one embodiment, the method includes manipulating a pre-made component within the working zone with a placement machine mounted to a placement machine actuator for three-dimensional motion relative to the print bed.

In one embodiment, the placement machine includes a gripping end effector. The method further includes initially gripping the pre-made component in a first location and moving the pre-made component to a second location with the gripping end effector, the second location being within the working zone; and releasing the pre-made component when located within the working zone.

In one embodiment, the method includes dispensing the first material before manipulating the pre-made component with the placement machine.

In one embodiment, the first additive machine dispenses a first portion of the first material prior to manipulating the pre-made component with the placement machine. The method further includes dispensing a second portion of the first material after releasing the pre-made component. In an alternative embodiment, the second portion could be dispensed by a second additive machine.

In one embodiment, the method includes preparing, with a surface preparation system, a first portion of the first material to receive a second portion of the first material after the first portion of the first material has been processed by the first subtractive machine. The method further includes dispensing the second portion of the first material after the step of preparing. In an alternative embodiment, the second portion could be dispensed by a second additive machine.

In one embodiment, the first additive machine is a pellet fed extruder. A hopper stores the first material in a pellet form prior to being dispensed in the working zone on the print bed.

In one embodiment, the hopper is operably fixed to the first additive machine actuator.

In one embodiment, the hopper includes a plurality of storage compartments for storing more than one type of pellet.

In one embodiment, a filling station located in a fixed location having a reserve supply of pellets the hopper. The method further includes moving the hopper to the filling station; and filling the hopper with additional pellets from the reserve supply.

In one embodiment, a pellet supply system between the hopper and the first additive machine maintains environmental conditions of the pellets prior to being dispensed.

In one embodiment, the method includes drying the pellets, with the pellet supply system to prevent the pellets from absorbing moisture.

In one embodiment, the hopper is located in a fixed position and does not move with the first additive machine as the first additive machine is moved within three dimensions within the working zone.

In one embodiment, the first additive machine is a spool fed extruder. A spool supplies the first material to the first additive machine. The spool is mounted to the first additive machine.

In one embodiment, the method includes automatically welding a tail end of a first spool of material being used by the first additive machine with a lead end of a second spool of material, with a spool reloader, when the first spool runs empty.

In one embodiment, the additive machine has a plurality of extruder heads for dispensing different materials. The method includes hands free swapping between the plurality of extruder heads, with an automatic tool changer.

In one embodiment, the method includes controlling the first additive machine and the first subtractive machine, with a controller communicating with the first additive machine and the first subtractive machine wirelessly.

In one embodiment, at least one of the first additive machine actuator and first subtractive machine actuator is a moving gantry.

In one embodiment, the method includes powering first additive machine or first subtractive machine with a power rail system delivering voltage power to the moving gantry.

In one embodiment, the method includes controlling operation of the corresponding first additive machine or first subtractive machine carried by the at least one of the first additive machine actuator and first subtractive machine actuator that is a moving gantry with a controller. The controller communicates control commands to the corresponding first additive machine or first subtractive machine wirelessly.

In one embodiment, the first additive machine actuator includes a gantry configured to move linearly along a guide rail forming a straight axis and wherein the first subtractive machine actuator includes a gantry configured to move linearly along the guide rail. The method includes forming the guide rail from a plurality of guide rail sections such that a desired length of the guide rail along the straight axis is provided. The method also includes forming the print bed from a plurality of print bed sections such that a desired length of the print bed along the straight axis is provided.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified perspective view of an embodiment of an additive and subtractive manufacturing system;

FIG. 2 is an alternative view of the additive and subtractive manufacturing system of FIG. 1; and

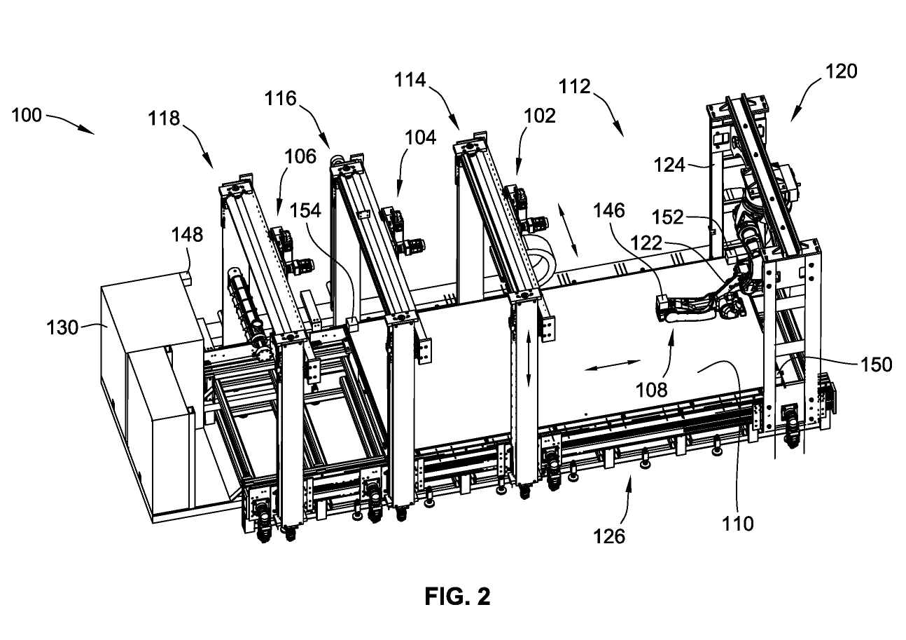

FIG. 3 is a simplified perspective view of the additive and subtractive manufacturing system including an environmental chamber.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

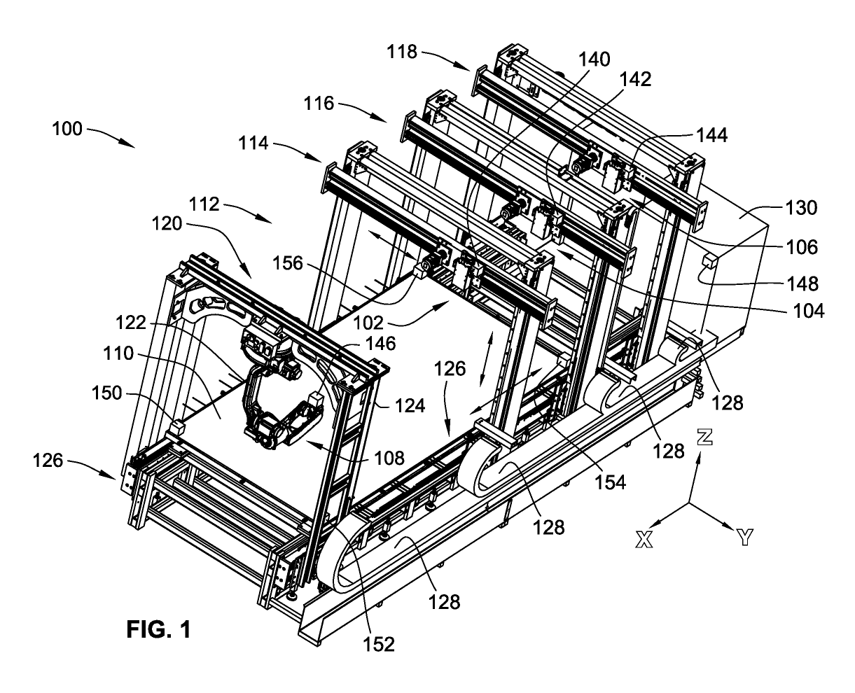

FIG. 1 is a simplified perspective illustration of an additive and subtractive manufacturing system 100 (also referred to as “system 100”) for forming products. The system 100 includes a plurality of different machines for forming products. More particularly, the system 100 includes processing equipment (also referred to as processing tooling) including a first, second and third additive machines 102, 104, 106 for dispensing material and at least one subtractive machine 108 for removing material that has been dispensed by one or more of the additive machines 102, 104, 106. By combining both additive capabilities and subtractive capabilities improved surface finishes, tighter tolerances and improved manufacturing times can be produced. Further, reduced manual labor for refixturing and calibration can reduce costs.

It is a significant benefit of the present system 100 that the system can provide both additive manufacturing and subtractive manufacturing to form a product without requiring refixturing of the product. Further, as will be described in more detail, the system can first perform additive manufacturing to form a portion of the product, then perform subtractive manufacturing without having to refixture the product. Further yet, after performing subtractive manufacturing, the system can then provide further additive manufacturing, again, without refixturing the product resulting in very high tolerances and repeatability.

In some embodiments, the system can include a third type of machine such as a placement machines that can manipulate a pre-made component within the work piece that is to be added to the end product. A pre-made component would be a piece that is not formed directly by dispensing material using one of the additive machines 102, 104, 106 to its desired final location. However a pre-made component could be formed using one of the additive machines 102, 104, 106, albeit with the piece not being is final location. The pre-made component could take the form as simple things such as nuts, bolts, threaded studs, electrical wires or could be as complex as electrical circuit boards such as printed circuit boards.

The placement machine could be in the form a robotic gripping end effector that can grab pre-made components and place them within the product. After being placed in a desired location, further material could be dispensed to hold pre-made component in place. Additionally, the subtractive machine could perform subtractive processing of the pre-made component (e.g. to remove the portion of the pre-made component that is gripped by the placement machine). However, again, all of this can be done without having to refixture the product being formed.

The particular system 100 illustrated, will now be described. The system 100 includes a print bed 110 configured to receive the material that is dispensed by the additive machines 102, 104, 106. A working zone 112 is defined adjacent to the print bed 110 where products can be formed by dispensing material from the additive machines 102, 104, 106 and material can be removed using the subtractive machine 108.

In this embodiment, the additive machines 102, 104, 106 are mounted to first, second and third additive machine actuators 114, 116, 118 that allow for three-dimensional motion of the additive machines 102, 104, 106, respectively, to allow for additive manufacturing processes. In the illustrated embodiments, the additive machine actuators 114, 116, 118 are illustrated in the form of three-axis gantries which permit linear motion parallel to three independent axes (x, y, z in FIG. 1) to allow for three-dimensional motion of the additive machines 102, 104, 106 within the working zone.

The additive machines 102, 104, 106 can take any form for providing additive manufacturing. For example, the additive machines 102, 104, 106 may be extruder type additive machines that melt and extrude material. The material may be in pellet form or spool form prior to being processed by the additive machines 102, 104,106. Further, the additive machines 102, 104, 106 may be configured to combine multiple starting materials to form the end material that is extruded. For instance, to provide different colors or finished material characteristics.

The additive machines 102, 104, 106 do not need to be the same. For instance, additive machine 102 may be a 1.75 mm spool fed extruder. Additive machine 104 may be a 2.85 mm spool fed extruder. Further, additive machine 106 may be a 6 mm spool fed extruder. Alternatively, one or more of the additive machines 102, 104, 106 could be a pellet fed extruder rather than using material filament.

While multiple additive machines 102, 104, 106 are provided, the system could have fewer actuators (or the same number) but where an automatic tool changer is provided that allows for swapping between different additive machine heads. Not only could the actuator switch between the different types of head providing additive machines identified above, the actuator could switch from an additive machine to a subtractive machine. Further yet, a machine head that is a pick and place gripper for providing a placement machine could also be provided. This could reduce the number of actuators that are present, but could reduce the production speed of the system. Further, the tool changer could be automated that allows for automatic hands-free swapping between the machine heads.

While not illustrated, in some embodiments, the spools of material could be located remote from the additive machines 102, 104, 106. However, it is contemplated that other embodiments could have spools or pellet hoppers mounted directly to the actuators 114, 116, 118 for movement with the additive machines 102, 104, 106. By mounting the spools or pellet hoppers directly to the actuators long, bulky expensive hoses from a pellet storage location to the additive machines 102, 104, 106 are eliminated. Further, those systems that utilize hoppers could have more than one hopper present for supplying materials of difference types. The additive machine could selectively receive material from the desired hopper.

In some embodiments where the hopper is carried on the actuator that controls the motion of the additive machine, an filling station located in a fixed location is provided. The filling station may have a larger supply of pellets than the hopper. In some embodiments, empty hoppers could be replaced with full hoppers. The first additive machine actuator and corresponding controls are configured to move the hopper to the filling station to add additional pellets to the hopper. A sensor can be provided to determine when the hopper is empty or nearing being empty such that the refilling procedure can be automatically initiated.

Other systems that utilize spool fed extruders can have the spools carried by the actuator. This eliminates long tubes of material that need to be feed from a stationary spool holder or storage location to the moving actuator (gantry in the illustrated system). This is particularly useful for larger systems 100 where the distance between the spool and the nozzle of the extruder becomes significantly long. By simply carrying the spool with the extruder, the distance between the extruder and the spool can be kept at a minimum.

Further, an automatic spool reloader can be provided. An automatic butt welder could be provided. When the material on one spool runs out, a lead end of the material of a second spool can be joined to a tail end of the material of first spool by using an automated device to align and melt the two pieces of material together. The spent spools can then be swapped with full spools to replenish the supply of material. In an alternative embodiment, as one spool runs out, the material of a second spool can be fed to the extruder by pushing material from the second spool to the extruder.

The additive machines 102, 104, 106 will typically form the product by dispensing multiple layers of material to build the product from the material that is dispensed.

The subtractive machine 108 is mounted to a subtractive machine actuator 120 that allows for three-dimensional motion of the subtractive machine to allow for precise subtractive processing of the product being formed within the working zone 112. The subtractive machine actuator 120 in the illustrated embodiment includes a robotic arm 122 mounted to a movable gantry 124. The robotic arm 122 could have numerous arm segments and provide for motion about multiple axes that provide for precise three-dimensional motion of the subtractive machine 108. For instance, the robotic arm could be a 6 or 7 axis robotic arm. In this embodiment, the gantry 124 simply provide motion parallel to the x-axis while motion in the robotic arm 122 provides motion in the x, y and z directions (e.g. along the x, y and z axes).

The subtractive machine 108 could take the form of substantially any subtractive machine for performing processes such as cutting, milling, sanding, drilling, routing, grinding, etc. of the material that is dispensed. Further, multiple subtractive machines can be provided on independent gantries or the robotic arm 122 can be configured to automatically switch between different subtractive machines for performing the different desirable operations. The subtractive machine 108 can incorporate computer numeric control.

Any combination of actuators could be implemented. For instance, all of the additive and subtractive machines could be mounted on gantries, all of the additive and subtractive machines could be mounted on robotic arms or alternative combinations are contemplated. For instance, some of the additive machines could be mounted on gantries while other of the additive machines could be mounted on robotic arms.

The system 100 includes a plurality of guide rails 126 for guiding the gantries parallel to the x-axis. Further, a plurality of cable carriers 128 extend between control system 130 and the actuators 114, 116, 118, 120.

The control system 130 operably controls the additive machines 102, 104, 106 and the subtractive machine 108 as well as the corresponding actuators 114, 116, 118, 120. In this embodiment, the control system 130 is a localized, stationary control system. In this embodiment, some or all of the power and control signals are sent to the individual additive machines and subtractive machine and corresponding actuators by wires within the cable carriers 128. However, other embodiments can incorporate power rails proximate or incorporated into guide rails 126 to supply power (typically high voltage power, e.g. greater than 90 volts) from a stationary portion of the system 100 to the actuators 114, 116, 118, 120 as well as to the processing equipment, e.g. the subtractive and additive machines 102, 104, 106, 108. In further embodiments, the control system 130 can communicate with the actuators and/or the actuators actuators 114, 116, 118, 120 the subtractive and additive machines 102, 104, 106, 108 via a wireless communications, such as for example blue tooth and Wi-Fi.

In some embodiments, the control system 130 may be decentralized for control of the additive and subtractive machines 102, 104, 106, 108 as well as for the corresponding actuators 114, 116, 118, 120.

For example, in some implementations, a small secondary/slave board on each actuator 114, 116, 118, 120 controls the actuator 114, 116, 118, 120 and the corresponding machine head, e.g. additive machine 102, 104, 106, or subtractive machine 108. This would only require a power cable and a communication cable to run to the actuator 114, 116, 118, 120 and the secondary/slave board would send signals to the components of the machine head to control the operations thereof, e.g. material dispensing, material heating, fans, subtractive actions, cleaning systems etc. This will eliminate the bulk of the cable carriers 128, reduce mass, reduce the force required to pull the cable carriers 128, eliminate cable failure points and reduce overall cost.

In another example, for larger machines, the secondary/slave board would be a local PLC (Programmable Logic Controller)/Motion Controller. Depending on the size, the secondary/slave board could also be used in addition to the PLC/Motion Controller. This is particularly true for larger implementations where the actuators could travel lengths reaching spans in excess of 100 meters. Running cables through traditional cable carriers of this length is difficult. Decentralizing the control and placing it onto the moving gantry significantly decreases the complexity and cost of the cables as you would only have to provide signal and power to the actuators 114, 116, 118, 120.

Further, this decentralized control could be replaced by or coupled with with the use of wireless control signals such as Wi-Fi and Bluetooth to send control messages from a stationary main control cabinet, such as control system 130 to the moving actuators 114, 116, 118, 120 and corresponding machine heads. This wireless control in combination with the power rail systems described above could be used to substantially eliminate the need for any wired connections between the actuators 114, 116, 118, 120 and corresponding additive and subtractive machines 102, 104, 106, 108 to any stationary components of the system such as a stationary control cabinet of control system 130.

Going one step further, if the locally mounted pellet hopper or material spools are also carried by the actuators 114, 116, 118, wires and hoses are completely eliminated which would allow for virtually unlimited travel lengths without the complexity or physical limitations or running cables/houses from the fixed part of the system 100 to the moving parts of the system 100. This also allows for easy scaling of the system by simply adding additional modules to length the print bed 110 and guide rails 126.

Typically, machine tools have cast metal bases. These castings require high tooling costs and are inflexible in design. The concept of allowing expansion by simply provide additional modules to expand the size of system 100 (e.g. along the x-axis) with any number of sections provides a highly flexible machine for simple customization for desired implementations.

One issue that must be overcome is that depending on the temperature of the various components of the system 100, and in particular, the print bed 110 thermal expansion can cause significant changes in the size of the components. In some situations, the print bed can grow due to thermal expansion more than 0.250 inches. However, this is often well outside manufacturing tolerances.

Each of the additive machines 102, 104, 106 and the subtractive machines has a communications module 140, 142, 144, 146 to further facilitate control and calibration of the corresponding machines. Further, the control system 130 can include a communication module 148 that can communicate command signals as well as assist in calibration. For instance, the communications module could be in the form of a position sensor. The position sensor could be used to determine a position relative to the print bed 110, the control system 130 (e.g. a fixed ground position) or the product being produced within the working zone 112.

More particularly, in some embodiments, one or more of the sensors could take the form of a contact sensor that directly contacts the print bed 110 or product or a non-contact sensor for determining a precise position of the print bed or to precisely locate and measure the product being produced. The non-contact sensor could be in the form of a light beam, inductive proximity sensor, radio waves etc.

The sensors can also be used to locate and calibrate the position of the processing tooling (e.g. additive and subtractive machines 102, 104, 106, 108). For instance, the control system 130 communication module 148 could provide two or more stationary transmitters that are spaced apart from one another that can be received by communications modules 140, 142, 144, 146 to allow for triangulation and a determination of the particular location of the corresponding processing tooling. While this is one implementation, the communications modules 140, 142, 144, 146 could alternatively be a transmitter that cooperates which send signals to stationary sensors.

The inclusion of the sensors provides one way to compensate for thermal expansion and contraction of both the components of the system 100 as well as the product being produced.

Beyond tracking the position of individual additive and subtractive machines, tracking of the thermal expansion of the print bed 110 can also occur. In the illustrated embodiment, communication modules 150, 152, 154, 156 are mounted to corners of the print bed 110 can be used to determine thermal expansion and contraction of the print bed. In one embodiment, one edge of the print bed 110 is fixed while the rest of the print bed 110 allowed to expand and contract in a controlled manner. The position of the communication modules 150, 152, 154, 156 can be used to determine changes in the print bed and to adjust control of the additive machines 102, 104, 106 and subtractive machine 108.

In some embodiments, the communication modules 150, 152, 156, 156 are simply visual indicators such as locating spheres for which the position can be monitored. This could be done using transmitters and receiver arrangements or simply using visual systems such as fixed position cameras.

In some implementations, one or more of the communications modules 140, 142, 144, 146 have temperature sensors for detecting the temperature of the product being manufactured. In many additive manufacturing processes, the material that has been dispensed must be cool enough that a next layer of material can be deposited onto the already dispensed material. By being able to directly monitor the temperature of the dispensed material, unnecessarily long cooling delays can be avoided while avoiding to wait long enough to allow for proper cooling.

When a product is made by first adding material, then subtracting material and then adding material again, it can be desirable to properly remove the subtracted material. As such, some embodiments include a waste material removal system. The waste material removal system may be carried with the subtractive machine 108 on the subtractive machine actuator 102. It is contemplated that the waste material removal system could be in the form of a vacuum system for sucking removed particulates generated by the subtractive machine 108.

Further, subtractive manufacturing using the subtractive machine 108 may leave the surface of the material that has already been dispensed not conducive to applying a new layer of material to the processed surface. Additional devices to prepare the manipulates surface for future layers of material may be provided. For instance, a chemical based cleaning or preparation system for preparing a surface for receipt of a subsequent layer of material may be provided.

In addition to maintaining a clean and proper working environment for the dispensed material, some systems may include one or more dryers for maintaining the material in a proper environmental condition prior to being used by the additive machines 102, 104, 106. For instance, a dryer could be mounted to the corresponding actuator. The dryer will ensure that optimum material physical properties of the material, particularly pelletized material, are maintained. This is particularly true for materials that are known to absorb moisture and lose their physical properties. Many materials that absorb moisture lose their ability to be properly extruded. The dryer will keep the moisture out of the materials to maintain consistent and proper extrusion.

While not illustrated, in some embodiments, the print bed 110 could be mounted to an actuator for allowing for changing the orientation of the print bed 110. For instance, the print bed 110 could be linear translated or tilted to allow for more precise dispensing of material and or more precise subtractive manufacturing. The ability to manipulate the print bed 110 could also allow for more complex geometries to be formed.

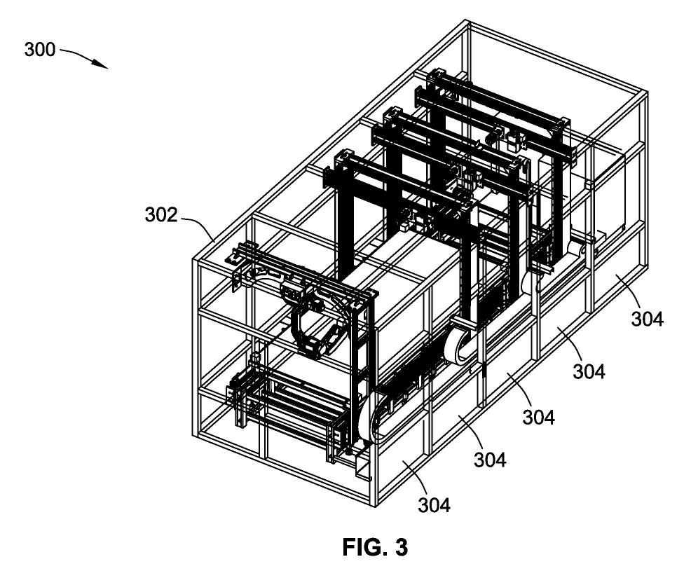

FIG. 3 illustrates a further embodiment, where the system 300 is substantially identical to system 100 except it includes an environmental chamber 302. The environment chamber 302 is movable and formed from a plurality of panels and is used to keep heat in and prevent undesirable gasses from escaping or preventing subtracted particles from escaping or contaminants from entering the working zone.

In this embodiment, the panels 304 are designed to fold adjacent one another to reduce the foot print of the environmental chamber 302 when is opened to remove parts or for maintenance/refilling operations. The panels 304 are operably connected to one another by vertically oriented hinge arrangements. As the machines become large to accommodate manufacture of larger components this type of foldable environment chamber 302 will allow access for cranes, forklifts or overhead gantries to lift and remove the parts that have been produced. Other embodiments may allow the panels 304 to stack inside one another similar to pocket doors.

Other environmental chambers 302 could use overhead doors similar to garage doors such that the panels would move vertically upward and over the actuators and additive and subtractive machines.

In an alternative embodiment of an additive and subtractive system, rather than using a substantially fixed print bed, the print bed rotates angularly about an axis of rotation. In this system, the machine heads, such as the additive and subtractive machines are mounted to robotic arms that have a fixed position. In this embodiment, the print bed is able to be index angularly about the axis of rotation to change the relative position of the machine heads relative to the working zone, e.g. the space above the print bed.

A placement machine can pick pre-made components from a storage region and place them in the working zone and adjacent the dispensed material. Thereafter, further material can be applied to hold the pre-made component. This additional material can be added by a same or different additive machine. Alternatively, no additional material may be required to maintain the pre-made component adjacent the dispensed material This system is capable of having all of the features described above, as if they have been expressly described with reference to this configuration.

Methods of operating the system 100 are also provided. For instance, in some methods, the method includes first performing additive manufacturing by dispensing material using the additive machines 102, 104, 106 onto print bed 110. Thereafter, the method includes subtractive manufacturing by removing material from the material that has been dispensed onto the print bed 110 using subtractive machine 108. Further, the method does this without refixturing the material that is first dispensed by the additive machines 102, 104, 106. This combination of both additive manufacturing and subtractive manufacturing can significantly improve tolerances in the manufacturing process.

Further, in addition to additive manufacturing and subtractive manufacturing, methods include installing pre-made components into an object that has been the subject of additive manufacturing as well as that may have been the subject of subtractive manufacturing. For instance, methods include first performing additive manufacturing, then placing a pre-made component adjacent the object made with additive manufacturing. The method can then optionally include subsequent additive manufacturing to secure the object in place.

The method could also optionally include subtractive manufacturing prior to placing the pre-made component adjacent the object made from the dispensed material. For instance, an object could be formed using additive manufacturing, a precise cavity could be formed in the object using subtractive manufacturing, an pre-made component could be placed in the cavity. This could be the end of the process or optionally, additional steps could be formed. For instance, further additive manufacturing could be performed to secure the pre-made component to the object. Further, subsequent subtractive manufacturing could be performed on the pre-made component or on the object formed from the additive manufacturing material. All of these steps can be performed without requiring refixturing of the material dispensed during the additive manufacturing steps.

Further, some methods will include performing additive manufacturing using more than one additive machine 102, 104, 106 simultaneously such that the additive manufacturing processes can be performed more rapidly. One of the current problems of additive manufacturing is the long cycle times. However, these times can be reduced if multiple additive machines 102, 104, 106 are operating simultaneously.

Further steps of calibrating and locating the various machine heads (e.g. additive and subtractive machines) may be performed before or simultaneous with additive and subtractive manufacturing steps.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An additive and subtractive manufacturing system for forming a product comprising:
a print bed;
a first additive machine mounted to a first additive machine actuator for three-dimensional motion relative to the print bed for dispensing a first material onto the print bed within a working zone; and
a first subtractive machine mounted to a first subtractive machine actuator for three-dimensional motion relative to the print bed for removing material dispensed on the print bed within the working zone from the first additive machine.

2. The system of claim 1, wherein the print bed is movable relative to the first and second additive machines to a first orientation where the working zone is positioned proximate the first additive machine and movable relative to a second orientation where the working zone is positioned proximate the first subtractive machine.

3. The system of claim 2, wherein the print bed rotates about an axis of rotation between the first and second orientations; and
wherein the first additive machine is angularly offset from the first subtractive machine about the axis of rotation.

4. The system of claim 1, wherein the first subtractive machine includes a sensor that measures a position of the print bed or the first material to determine a location of the first subtractive machine.

5. The system of claim 4, wherein the sensor is a contact sensor that directly contacts the print bed or the first material.

6. The system of claim 4, wherein the sensor is a non-contact sensor.

7. The system of claim 1, wherein the first additive machine includes a sensor that measures a position of the print bed or the first material to determine a location of the first subtractive machine.

8. The system of claim 7, wherein the sensor is a contact sensor that directly contacts the print bed or the first material.

9. The system of claim 7, wherein the sensor is a non-contact sensor.

10. The system of claim 1, further including a tooling position monitoring system including:
a first sensor and at least first and second transmitters, wherein the first sensor receives signals from the first and second transmitters;
wherein one of the first sensor and at least first and second transmitters is attached to at least one of the first additive machine and the first subtractive machine and at least two of the first sensor and at least first and second transmitters are in fixed positions;
wherein the tooling position monitoring system can determine the position of the one of the first sensor and at least first and second transmitters attached to at least one of the first additive machine and the first subtractive machine based on the first sensor receiving signals from the first and second transmitters.

11. The system of claim 10, wherein the first sensor is attached to and movable with the first additive machine and the first and second transmitters are in fixed positions.

12. The system of claim 11, wherein the first and second transmitters transmit either a radio signal or a light signal.

13. The system of claim 1, further comprising at least one sensor mounted to the print bed to detect a position of the bed; further comprising a controller configured to sense a change in position of the at least one sensor due to thermal expansion and contraction of the print bed and to and adjust control of the first additive machine and first subtractive machine based on the sensed change in position of the at least one sensor.

14. The system of claim 1, further comprising at least one sensor mounted to the first additive machine for sensing a temperature of the first material after the first material has been dispensed; further comprising a controller configured to use the sensed temperature to determine whether a second material can be placed on the first material.

15. The system of claim 14, wherein the first and second materials are the same type of material but the first material is a first layer of material and the second material is a second layer of material placed in contact with the first layer of material.

16. The system of claim 1, further comprising a waste material removal system for removing waste material removed by the first subtractive machine from the working zone.

17. The system of claim 16, wherein the waste material removal system is operably moved with the first subtractive machine.

18. The system of claim 16, wherein the waste material removal system is a vacuum system.

19. The system of claim 1, further comprising an environmental enclosure surrounding the first additive machine, first subtractive machine and the print bed.

20. The system of claim 19, wherein the environmental enclosure is a movable enclosure to provide access to the work zone for removal of a component formed in the working zone.

21. The system of claim 20, wherein the environmental enclosure includes a plurality of sections that fold or slide adjacent one another to provide access to the working zone.

22. The system of claim 20, wherein the environmental enclosure includes a plurality of sections that stack inside one another to provide access to the working zone.

23. The system of claim 1, further comprising a second additive machine for dispensing a second material in the working zone.

24. The system of claim 23, wherein the first and second materials are different from one another in at least one of material type, material size, or material form.

25. The system of claim 23, wherein the first and second additive machines are different from one another in at least one of type or size.

26. The system of claim 25, wherein the first additive machine is a spool fed extruder and the second additive machine is a pellet fed extruder.

27. The system of claim 1, further comprising a placement machine mounted to a placement machine actuator for three-dimensional motion relative to the print bed for manipulating a pre-made component within the working zone.

28. The system of claim 27, wherein the placement machine includes a gripping end effector and is configured to initially grip the pre-made component in a first location and moving the pre-made component to a second location, the second location being within the working zone, and releasing the pre-made component when located within the working zone.

29. The system of claim 28, wherein the first additive machine is configured to dispense the first material before and after the placement machine manipulates the pre-made component.

30. The system of claim 28, wherein the first additive machine is configured to dispense a first portion of the first material prior to manipulation of the pre-made component with the placement machine and to dispense a second portion of the first material after the placement machine releases the pre-made component.

31. The system of claim 1, further comprising a surface preparation system configured to prepare a first portion of the first material to receive a second portion of the first material after the first portion of the first material has been processed by the first subtractive machine.

32. The system of claim 1, wherein the first additive machine is a pellet fed extruder; further including a hopper for storing the first material in a pellet form prior to being dispensed in the working zone on the print bed.

33. The system of claim 32, wherein the hopper is operably fixed to the first additive machine actuator.

34. The system of claim 33, wherein the hopper includes a plurality of storage compartments for storing more than one type of pellet.

35. The system of claim 33, further comprising a filling station located in a fixed location having a reserve supply of pellets the hopper; the first additive machine actuator being configured to move the hopper to the filling station to add additional pellets to the hopper from the reserve supply.

36. The system of claim 32, further including a pellet supply system between the hopper and the first additive machine to maintain environmental conditions of the pellets prior to being dispensed.

37. The system of claim 32, wherein the pellet supply system includes a dryer to prevent the pellets from absorbing moisture.

38. The system of claim 36, wherein the hopper is located in a fixed position and does not move with the first additive machine as the first additive machine is moved within three dimensions within the working zone.

39. The system of claim 1, wherein the first additive machine is a spool fed extruder; further including a spool for supplying the first material to the first additive machine; wherein the spool is mounted to the first additive machine.

40. The system of claim 39, further comprising a spool reloader configured to automatically weld a tail end of a first spool of material being used by the first additive machine with a lead end of a second spool of material when the first spool runs empty.

41. The system of claim 1, wherein the additive machine has a plurality of extruder heads for dispensing different materials; further including an automatic tool changer configured for hands free swapping between the plurality of extruder heads.

42. The system of claim 1, further comprising a controller for controlling the first additive machine and the first subtractive machine, the controller communicating with the first additive machine and the first subtractive machine wirelessly.

43. The system of claim 1, wherein at least one of the first additive machine actuator and first subtractive machine actuator is a moving gantry.

44. The system of claim 43, further including a power rail system delivering voltage power to the moving gantry to power the corresponding first additive machine or first subtractive machine.

45. The system of claim 44, further comprising a controller for controlling operation of the corresponding first additive machine or first subtractive machine carried by the at least one of the first additive machine actuator and first subtractive machine actuator that is a moving gantry; wherein the controller communicates control commands to the corresponding first additive machine or first subtractive machine wirelessly.

46. The system of claim 1, wherein the first additive machine actuator includes a gantry configured to move linearly along a guide rail forming a straight axis and wherein the first subtractive machine actuator includes a gantry configured to move linearly along the guide rail; wherein the guide rail is formed from a plurality of guide rail sections such that a length of the guide rail along the straight axis can be adjusted and the print bed is formed from a plurality of print bed sections such that a length of the print bed along the straight axis can be adjusted.

47. A method of manufacturing a product using the system of claim 1, the method comprising:
dispensing a first material, with the first additive machine, onto the print bed within the working zone; and
removing a portion of the first material, with the first subtractive machine within the work zone.

48. The method of claim 47, wherein the print bed is movable relative to the first and second additive machines to a first orientation where the working zone is positioned proximate the first additive machine and movable relative to a second orientation where the working zone is positioned proximate the first subtractive machine;
the method further comprising:
repositioning the print bed relative to the first and second additive machines by moving the print bed between the first and second orientations.

49. The method of claim 48, wherein the print bed rotates about an axis of rotation between the first and second orientations; wherein the first additive machine is angularly offset from the first subtractive machine about the axis of rotation;
the method further includes rotating the print bed about the axis of rotation.

50. The method of claim 47, wherein the first subtractive machine includes a sensor that measures a position of the print bed or the first material to determine a location of the first subtractive machine;
the method further comprising sensing a position of the print bed or the first material with the sensor.

51. The method of claim 50, wherein the sensor is a contact sensor that directly contacts the print bed or the first material; and the step of sensing includes directly contacting the print bed or the first material.

52. The method of claim 50, wherein the sensor is a non-contact sensor.

53. The method of claim 47, wherein the first additive machine includes a sensor that measures a position of the print bed or the first material to determine a location of the first subtractive machine;
the method further comprising sensing a position of the print bed or the first material with the sensor.

54. The method of claim 53, wherein the sensor is a contact sensor that directly contacts the print bed or the first material.

55. The method of claim 53, wherein the sensor is a non-contact sensor.

56. The method of claim 47, further including determining a position of at least one of the first additive machine and the first subtractive machine with a tooling position monitoring system including:
a first sensor and at least first and second transmitters,
the method further includes receives signals from the first and second transmitters with the first sensor;
wherein one of the first sensor and at least first and second transmitters is attached to at least one of the first additive machine and the first subtractive machine and at least two of the first sensor and at least first and second transmitters are in fixed positions; and
wherein the tooling position monitoring system determines the position of the one of the first sensor and at least first and second transmitters attached to at least one of the first additive machine and the first subtractive machine based on the first sensor receiving signals from the first and second transmitters.

57. The method of claim 56, further including moving the first sensor with the first additive machine and the first and second transmitters are in fixed positions.

58. The method of claim 57, wherein the first and second transmitters transmit either a radio signal or a light signal.

59. The method of claim 47, further comprising detecting a position of the print bed with at least one sensor mounted to the print bed; further comprising sensing a change in position of the at least one sensor, with a controller, due to thermal expansion and contraction of the print bed; further comprising adjusting control of the first additive machine and first subtractive machine based on the sensed change in position of the at least one sensor.

60. The method of claim 47, further comprising sensing a temperature of the first material, with at least one sensor mounted to the first additive machine, after the first material has been dispensed; further comprising determining whether a second material can be placed on the first material, based on the sensed temperature.

61. The method of claim 60, wherein the first and second materials are the same type of material but the first material is a first layer of material and the second material is a second layer of material placed in contact with the first layer of material.

62. The method of claim 47, further comprising removing waste material removed by the first subtractive machine with a waste material removal system, from the working zone.

63. The method of claim 62, further comprising operably moving the waste material removal system with the first subtractive machine.

64. The method of claim 62, wherein the waste material removal system is a vacuum system.

65. The method of claim 47, further comprising surrounding the first additive machine, first subtractive machine and the print bed by an environmental enclosure.

66. The method of claim 65, wherein the environmental enclosure is a movable enclosure to provide access to the work zone for removal of a component formed in the working zone.

67. The method of claim 66, wherein the environmental enclosure includes a plurality of sections that fold or slide adjacent one another to provide access to the working zone.

68. The method of claim 66, wherein the environmental enclosure includes a plurality of sections that stack inside one another to provide access to the working zone.

69. The method of claim 47, further comprising dispensing a second material in the work zone with a second additive machine.

70. The method of claim 49, wherein the first and second materials are different from one another in at least one of material type, material size, or material form.

71. The method of claim 49, wherein the first and second additive machines are different from one another in at least one of type or size.

72. The method of claim 71, wherein the first additive machine is a spool fed extruder and the second additive machine is a pellet fed extruder.

73. The method of claim 47, further comprising manipulating a pre-made component within the working zone with a placement machine mounted to a placement machine actuator for three-dimensional motion relative to the print bed.

74. The method of claim 73, wherein the placement machine includes a gripping end effector, the method further comprising:
initially gripping the pre-made component in a first location and moving the pre-made component to a second location with the gripping end effector, the second location being within the working zone; and
releasing the pre-made component when located within the working zone.

75. The method of claim 74, further comprising dispensing the first material before manipulating the pre-made component with the placement machine.

76. The method of claim 74, wherein the first additive machine dispenses a first portion of the first material prior to manipulating the pre-made component with the placement machine;
the method further comprising dispensing a second portion of the first material after releasing the pre-made component.

77. The method of claim 47, further comprising preparing, with a surface preparation system, a first portion of the first material to receive a second portion of the first material after the first portion of the first material has been processed by the first subtractive machine;
further comprising dispensing the second portion of the first material after the step of preparing.

78. The method of claim 47, wherein the first additive machine is a pellet fed extruder; further including a hopper for storing the first material in a pellet form prior to being dispensed in the working zone on the print bed.

79. The method of claim 78, wherein the hopper is operably fixed to the first additive machine actuator.

80. The method of claim 79, wherein the hopper includes a plurality of storage compartments for storing more than one type of pellet.

81. The method of claim 79, further comprising a filling station located in a fixed location having a reserve supply of pellets the hopper;
the method further comprising:
moving the hopper to the filling station; and
filling the hopper with additional pellets from the reserve supply.

82. The method of claim 78, further including a pellet supply system between the hopper and the first additive machine to maintain environmental conditions of the pellets prior to being dispensed.

83. The method of claim 78, further including drying the pellets, with the pellet supply system, to prevent the pellets from absorbing moisture.

84. The method of claim 82, wherein the hopper is located in a fixed position and does not move with the first additive machine as the first additive machine is moved within three dimensions within the working zone.

85. The method of claim 47, wherein the first additive machine is a spool fed extruder; further including a spool for supplying the first material to the first additive machine; wherein the spool is mounted to the first additive machine.

86. The method of claim 85, further comprising automatically welding a tail end of a first spool of material being used by the first additive machine with a lead end of a second spool of material, with a spool reloader, when the first spool runs empty.

87. The method of claim 47, wherein the additive machine has a plurality of extruder heads for dispensing different materials; further including hands free swapping between the plurality of extruder heads, with an automatic tool changer.

88. The method of claim 47, further comprising controlling the first additive machine and the first subtractive machine, with a controller communicating with the first additive machine and the first subtractive machine wirelessly.

89. The method of claim 47, wherein at least one of the first additive machine actuator and first subtractive machine actuator is a moving gantry.

90. The method of claim 89, further including powering first additive machine or first subtractive machine with a power rail system delivering voltage power to the moving gantry.

91. The method of claim 90, further comprising:
controlling operation of the corresponding first additive machine or first subtractive machine carried by the at least one of the first additive machine actuator and first subtractive machine actuator that is a moving gantry with a controller;
wherein the controller communicates control commands to the corresponding first additive machine or first subtractive machine wirelessly.

92. The method of claim 47, wherein the first additive machine actuator includes a gantry configured to move linearly along a guide rail forming a straight axis and wherein the first subtractive machine actuator includes a gantry configured to move linearly along the guide rail; further comprising:
forming the guide rail from a plurality of guide rail sections such that a desired length of the guide rail along the straight axis is provided; and
forming the print bed from a plurality of print bed sections such that a desired length of the print bed along the straight axis is provided.
